(19) United States
(12) Patent Application Publication
(10) Pub. No.: US 2007/0082961 A1
(43) Pub. Date: Apr. 12, 2007

(54) Blowing agent mixtures

(75) Inventor: Lothar Zipfel, Laatzen (DE)

Correspondence Address: CONNOLLY BOVE LODGE & HUTZ, LLP, P O BOX 2207, WILMINGTON, DE, 19899, US

(73) Assignee: SOLVAY S.A., Brussels (BE)

(21) Appl. No.: 10/580,490

(22) PCT Filed: Nov. 25, 2004
(86) PCT No.: PCT/EP04/53108

§ 371 Date: Oct. 4, 2006

(30) Foreign Application Priority Data
Nov. 26, 2003 (EP) 03104382.1

(51) Int. Cl. C09K 5/04; C08J 9/00

(52) U.S. Cl. 521/79; 252/67

(57) ABSTRACT

The invention concerns blowing agents mixtures containing at least a partially fluorinated hydroncarbon and the usual auxiliaries and additives, in which the inert gas content, measured in the vapour phase of the blowing agent or blowing agent mixture, should not exceed 1.5% by volume. The blowing agent mixture can be used to manufacture foam products from thermnoplastics, especially foamed polystyrene.

The present invention concerns blowing agent mixtures based on fluorinated hydrocarbons and conventional auxiliaries and additives as well as their use for the manufacture of thermoplastic foams.

The use of partly fluorinated hydrocarbons as blowing agents for the manufacture of foamed plastics is already known. Foamed plastics can be used in the form of sheets as heat and sound insulating elements.

U.S. Pat. No. 5,276,063 discloses a process for the manufacture of extruded, closed-cell polymers using a blowing agent mixture containing 1,1-difluoroethane and another blowing agent with a lower vapour pressure and higher solubility in the polymer.

U.S. Pat. No. 5,204,169 discloses the manufacture of foamed thermoplastics using polyfluorinated hydrocarbons with 2 C-atoms.

WO 02/051919 discloses a blowing agent mixture which contains fluorinated hydrocarbons with a boiling point >30° C. and <120° C., low-boiling alcohols and low-boiling carbonyl compounds. It is further evident from this document that inorganic blowing agents such as nitrogen, water or air may be contained in the blowing agent mixture without the foam properties being adversely influenced.

The task of the invention is to provide a blowing agent mixture which can be used for the extrusion of thermoplastic foams, preferably for the extrusion of foamed polystyrene.

The task is solved by a blowing agent or blowing agent mixture based on fluorinated hydrocarbons with an inert gas portion, measured in the vapour phase of the blowing agent or blowing agent mixture, of not more than 1.5% by volume.

According to one example of embodiment of the invention, the blowing agent mixture measured in the vapour phase contains 0.1 to 0.8% by volume, or preferably 0.4 to 0.6% by volume inert gas.

Specially preferred blowing agent mixtures contain 0.1 to 0.6% by volume inert gas, measured in the vapour phase.

Inert gas according to the invention means inert gases with an atmospheric boiling point below 120 K, especially nitrogen or preferably air.

The blowing agent mixtures according to the invention are particularly suitable for the manufacture of thermoplastic foams, especially according to the extrusion method. In this method the plastics containing the blowing agent are extruded directly into foamed sheets, films or profiles. The plastic mass foams immediately after leaving the nozzle. Plastics are especially to be understood as alkylene-aromatic polymers, e.g. polystyrene.

For example, foams, preferably polystyrene foam sheets, can be manufactured using the blowing agent mixture according to the invention.

Preferably the blowing agents and blowing agent compositions disclosed in WO 99/61519 are suitable as blowing agents. For example, a blowing agent or blowing agent composition can be used which contains at least one blowing agent selected from the group comprising difluoromethane; difluoroethane, preferably 1,1-difluoroethane (HFC-152a); tetrafluoroethane, preferably 1,1,2,2-tetrafluoroethane (HFC-134), 1,1,1,2-tetrafluoroethane (HFC-134a); pentafluoropropane, preferably 1,1,1,3,3-pentafluoropropane (C-245fa); pentafluorobutane, preferably 1,1,1,3,3-pentafluorobutane (HFC-365mfc); hexafluoropropane, preferably 1,1,1,3,3,3-hexafluoropropane (HFC-236fa), 1,1,2,3,3,3-hexafluoropropane (HFC-236ea); heptafluoropropane, preferably 1,1,1,2,3,3,3-heptafluoropropan (HFC-227ea), low-boiling, possibly halogenated hydrocarbons; low-boiling, possibly halogenated ethers; low-boiling alcohols, preferably ethanol.

Preferred blowing agent mixtures contain 1,1-difluoroethane and/or 1,1,1,2-tetrafluoroethane. When a mixture of 1,1-difluoroethane and 1,1,1,2-tetrafluoroethane is used, the content of 1,1-difluoroethane is often at least 30% by weight relative to the total content of 1,1-difluoroethane and 1,1,1,2-tetrafluoroethane. Preferably, this content is at least 50% by weight. When a mixture of 1,1-difluoroethane and 1,1,1,2-tetrafluoroethane is used, the content of 1,1-difluoroethane is often at most 70% by weight relative to the total content of 1,1-difluoroethane and 1,1,1,2-tetrafluoroethane.

In another embodiment, the fluorinated hydrocarbon in the blowing agent mixture according to the invention consists essentially of 1,1-difluoroethane.

Optionally these particular mixtures contain in addition at least one alcohol, in particular ethanol.

The blowing agent mixture may contain further auxiliaries and additives as necessary. For example, chemical blowing agents such as water can additionally be used. Also suitable are catalysts such as tertiary amines and/or organic metal compounds. Surfactant additives such as emulsifiers or foam stabilizers can be used, for example siloxane polyether copolymers, reaction retardants, cell regulators such as paraffins, fatty alcohol or dimethylpolysiloxanes, pigments, dyes, flame retardants such as phosphate esters or phosphonate esters. Also usable are stabilizers against the effects of ageing or weathering, plasticizers, fillers, dyes, antistatics, nucleating agents, pore regulating agents or biocidal agents.

The blowing agent according to the invention can also be used as such, without the aforementioned auxiliaries and additives.

It has been found that the use of the blowing agent or blowing agent mixture according to the invention can provide improved, physically homogeneous foam quality in the manufacture of foams.

A further advantage is the resulting improvement in the thermal conductivity of the thermoplastic foams.

The following examples are provided to explain the invention without restricting its scope.

### Example 1:

In an extrusion plant, 210 kg/h polystyrene with HFC-152a and an air content of 0.5% by volume, measured in the vapour phase of the blowing agent, was foamed at a flow rate of 19 kg/h HFC-152a to produce foam sheets.

| | |
|---|---|
| Foam density | 35.5 kg/m³ |
| Sheet thickness | 55 mm |

Example 2:
Analogous to Example 1.

| | |
|---|---|
| Air content, determined in the vapour phase: | 0.5% by volume |
| Flow rate (blowing agent): | 22 kg/h |
| Blowing agent mixture: | HFC-134a and HFC-152a |
| | in a 30:70 ratio |

Example 3:
Analogous to Example 1.

| | |
|---|---|
| Air content, determined in the vapour phase: | 0.5% by volume |
| Flow rate (blowing agent): | 24 kg/h |
| Blowing agent mixture: | HFC-134a and HFC-152a |
| | in a 50:50 ratio. |

### Example 4:

Examples 1 to 3 were repeated in the presence of ethanol to improve process control.

1-10. (canceled)

11. A blowing agent mixture which comprises fluorinated hydrocarbons, auxiliaries and additives, wherein the inert gas content, measured in the vapor phase of the blowing agent or blowing agent mixture, is not more than 1.5% by volume.

12. The blowing agent mixture according to claim 11, wherein the inert gas content, measured in the vapor phase of the blowing agent or blowing agent mixture, is 0.1 to 0.8% by volume.

13. The blowing agent mixture according to claim 11, wherein the inert gas content, measured in the vapor phase of the blowing agent or blowing agent mixture, is 0.1 to 0.6% by volume.

14. The blowing agent mixture according to claim 11, wherein the inert gases are air or nitrogen.

15. The blowing agent mixture according to claim 11, wherein the blowing agent mixture contains as fluorinated hydrocarbons at least one blowing agent selected from the group consisting of difluoromethane; difluoroethane, tetrafluoroethane; pentafluoropropane; pentafluorobutane; hexafluoropropane; and heptafluoropropane.

16. The blowing agent mixture according to claim 11, wherein the blowing agent mixture contains 1,1-difluoroethane or 1,1,1,2-tetrafluoroethane.

17. The blowing agent mixture according to claim 15, wherein the blowing agent mixture contains as fluorinated hydrocarbons at least one blowing agent from the group consisting of 1,1-difluoroethane; 1,1,1,2-tetrafluoroethane; 1,1,1,3,3-pentafluoropropane; 1,1,1,3,3-pentafluorobutane; 1,1,1,3,3,3-hexafluoropropane; and 1,1,1,2,3,3,3-heptafluoropropane.

18. The blowing agent mixture according to claim 16, which comprises a mixture of 1,1-difluoroethane and 1,1,1,2-tetrafluoroethane wherein the content of 1,1-difluoroethane is from 30% to 70 by weight relative to the total content of 1,1-difluoroethane and 1,1,1,2-tetrafluoroethane.

19. The blowing agent mixture according to claim 16, wherein the fluorinated hydrocarbon consists essentially of 1,1-difluoroethane.

20. The blowing agent mixture according to claim 11 which contains in addition at least one alcohol.

21. The blowing agent mixture according to claim 20, wherein the at least one alcohol is ethanol.

22. A process for the manufacture of thermoplastic foams which comprises extrusion process using a blowing agent mixture, wherein said blowing agent mixture is according to claim 11.

23. A process for the manufacture of polystyrene foams which comprises extrusion process using a blowing agent mixture, wherein said blowing agent mixture is according to claim 11.
